(19) United States
(12) Patent Application Publication
(10) Pub. No.: US 2007/0223599 A1
(43) Pub. Date: Sep. 27, 2007

(54) Cellular PC modem architecture and method of operation

(75) Inventors: Ming-Jye Sheng, Basking Ridge, NJ (US); Ho Young Lee, Bridgewater, NJ (US)

Correspondence Address: THELEN REID BROWN RAYSMAN & STEINER LLP, P. O. BOX 640640, SAN JOSE, CA, 95164-0640, US

(73) Assignee: Sysair, Inc., a Delaware Corporation

(21) Appl. No.: 11/493,370

(22) Filed: Jul. 25, 2006

Related U.S. Application Data
(60) Provisional application No. 60/595,646, filed on Jul. 25, 2005.

(51) Int. Cl. H04L 27/00

(52) U.S. Cl. 375/259

(57) ABSTRACT

A cellular personal computer (CPC) modem architecture performs radio frequency (RF) processing at the CPC modem hardware level and some or all CPC modem baseband processing is carried out on a processor (CPU) of an electronic computing device.

### STATEMENT OF RELATED APPLICATION(S)

The present application claims the benefit of priority under 35 U.S.C. Sec. 119(e) based on U.S. Provisional Patent Application Ser. No. 60/595,646, filed on Jul. 25, 2005, in the name of Dr. Ming-Jye Sheng, Mr. Ho Young Lee and Dr. Chang-Jia Wang, having the title “Apparatus for Synchronization and Adaptive Resource Management on Cellular PC Modem,” and commonly owned herewith.

### FIELD OF THE INVENTION

This invention relates to cellular data telecommunications modems (also known as cellular personal computer (CPC) modems) useable with portable or non-portable electronic computing devices such as laptop computers, personal data assistants (PDAs), and the like. More specifically, this invention relates to a new architecture for implementing such modems.

### BACKGROUND OF THE INVENTION

The recent expansion of cellular wireless data communications networks throughout the world, and particularly the introduction of high-speed wireless data networks such as AT&T Wireless' Universal Mobile Telecommunication System (UMTS) network and Verizon Wireless' Code Division Multiple Access (CDMA) 1× Evolution-Data Optimized (1×EV-DO) (CDMA EVDO) network in the United States and similar systems overseas, have made using a cellular-based wireless connectivity solution a realistic option for laptop, Personal Data Assistant (PDA) and other electronic computing device users. Manufacturers have seen significant increases in the number of Cellular Personal Computer (CPC) modem sales since 2003, both through wireless operator channels and through resellers, including laptop manufacturers.

The wireless telecommunications industry has long offered wireless data options for laptop users needing to access the Internet remotely using wireless Wide Area Networks (wireless WANs). Until recently, users had to be satisfied with relatively low data rates ranging from 8 to 14.4 Kbps over older cellular data networks using Cellular Digital Packet Data (CDPD), the CDMA IS-95b standard, or early Global System for Mobile Communications (GSM) standards. Most users of these earlier generation cellular data services worked with specific applications that did not require particularly high data rates. Over the course of the last decade faster cellular data networks using General Packet Radio Services (GPRS) or CDMA Single Carrier (1×) Radio Transmission Technology (1×RTT) have offered data rates ranging from 30 to 70 Kbps, which makes them relatively equivalent to landline dial-up speeds. Nevertheless, in comparison to T1 digital network, Digital Subscriber Line (DSL), and cable Internet speeds to which many computer users have become accustomed, these slower data rates have led many electronic computing device users to forego the convenience of anytime/anywhere data communications network access due to the unacceptably low available data rates.

The introduction of high-speed wireless data networks (EDGE (Enhanced Data rate for GSM Evolution)/UMTS, and CDMA EVDO) has changed the dynamic of the CPC modem market. Prior to 2002 the number of CPC modems being shipped each year was measured in the tens of thousands by all but the largest CPC modem manufacturer, and the total number of CPC modems shipped was less than half a million worldwide, with the United States making up the bulk of that market. In 2002 the number of CPC modems shipped exceeded three quarters of a million, with two thirds of those units being sold in the United States.

What is needed is a CPC modem with a new architecture that will help electronic computing device manufacturers and wireless operators meet customer need for high-speed wireless WAN connectivity solutions in at least two perspectives: cost reduction and flexible value added service through software download.

### BRIEF DESCRIPTION OF THE INVENTION

In accordance with the present invention a CPC modem architecture is presented wherein CPC modem radio frequency (RF) processing is carried out at the CPC modem hardware level and some or all CPC modem baseband processing is carried out on a processor (CPU) of an electronic computing device such as a personal computer, laptop computer, PDA or the like. An advantage of this approach is reduced cost in the CPC modem hardware because it has less to do, i.e., providing sampled “chips” of baseband data to the CPU. Another advantage of this approach is the use of the CPU to handle the baseband processing since such CPUs generally have more than adequate unused computing resources to handle the baseband processing task. By splitting the operation of the CPC modem in this way, it is relatively easy and inexpensive to update or upgrade the CPC modem by upgrading the software running on the CPU rather than replacing the CPC modem hardware. Thus, if a telecommunications standard changes, or a new standard emerges, or the user moves from a location supporting one standard to a location supporting another standard, the changes may be enabled by downloading new software to the electronic computing device. Furthermore, this architecture is particularly well suited to enabling integration of the CPC modem hardware into the motherboard of a laptop or other electronic computing device. Methods and apparatus for adaptive resource management and CPC modem synchronization are also provided to improve operation of the CPC modem. The architecture is applicable to existing 3G and 4G systems as well as WCDMA, HSDPA (also known as “3.5G”), CDMA-2000 (currently used in the United States by Verizon Wireless and Sprint), TD-SCDMA (used in China), WiFi/WiMAX/IEEE 802.11 networks and the like.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1A is a system block diagram illustrating a conventional cellular data communications network in accordance with the prior art;

FIG. 1B is a system block diagram illustrating a traditional CPC modem in accordance with the prior art;

FIG. 1C is a system block diagram illustrating a first embodiment of a CPC modem in accordance with the present invention;

FIG. 1D is a system block diagram illustrating a second embodiment of a CPC modem in accordance with the present invention;

FIG. 2 is a system block diagram of the hardware portion (telecommunications device) of a CPC modem in accordance with one embodiment of the present invention;

FIG. 3 is a process flow diagram illustrating the operation of a CPC modem controller, such as that illustrated in FIG. 2, in accordance with one embodiment of the present invention;

FIG. 4 is a system block diagram illustrating integration scenarios of layers L1, L2, L3, and a CPC modem controller in accordance with one embodiment of the present invention.

FIG. 5A is a table showing a resource allocation scenario wherein the functions of layers L2 and L3 and a portion of the functions of layer L1 are carried out in software on a CPU associated with the electronic computing device in accordance with one embodiment of the present invention;

FIG. 5B is a table showing a resource allocation scenario wherein the functions of layers L2 and L3 are carried out in software on a processor associated with the electronic computing device and the functions of layer L1 are carried out in hardware of the CPC modem in accordance with one embodiment of the present invention;

FIG. 6A is a system block diagram illustrating the functional blocks of the software component of the CPC modem executed by the processor of an electronic computing device to which the CPC modem is coupled in accordance with one embodiment of the present invention; and

FIG. 6B is a system block diagram illustrating the arrangement of major components of an electronic computing device for running the software of FIG. 6A.

### DETAILED DESCRIPTION

Embodiments of the present invention are described herein in the context of a novel CPC modem architecture. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

Cellular data communications comprise “chips” of analog data carrying digital data modulated onto an RF signal having a frequency allocated for cellular communications—on the receive side these are sampled by an A/D converter to produce a digital signal which can be further processed—similarly on the transmit side digital data is converted into chips, a D/A converter then converts chips into an analog signal, and the analog signal is up-converted in an RF module for transmission on appropriate frequencies. The “chip rate” is the rate at which chips are transmitted to and received from the cellular telecommunications network. The sampling rate is the rate at which the A/D and D/A converters sample. The sampling rate is an integer multiple of the chip rate.

In one embodiment of the present invention, the sampling rate at which the A/D and D/A converters operate to convert analog chips to and from digital samples which are communicated to and from the CPU for further processing is limited to two times the chip rate (the rate at which chips are transmitted to and from the cellular telecommunications network). This acts to limit the bandwidth of the sample in an acceptable manner and constrain the complexity of the computing task to that necessary to carry out the data communications function. The interpolation of two times oversampled data is further processed by the CPU to help recover the received signal quality.

As used herein, the “layers” L1, L2 and L3 correspond to the well known OSI network model. Layer L1 corresponds to the physical layer providing baseband processing in this implementation. Baseband processing corresponds to the processing of sampled data that has been demodulated by the RF and A/D-D/A stages described above. Layer L2 corresponds to the data link layer which implements, for example, the data link sublayer protocols RLC (radio link control) and MAC (media access control). Layer L3 corresponds to the network layer and implements sublayer protocols such as the framing protocol (FP), radio resource configuration (RRC) protocol, mobility management (MM) protocol, and the like. Such protocols and their implementation in cellular data communications networks are well known and the subject of standards such as the 3gpp standard (in its various versions), accordingly, they will not be described further herein.

In accordance with one embodiment of the present invention, the hardware portion of the CPC modem implementation is configured to provide the following L1 functions:

Response to Power Change of Uplink Closed Loop Power Control in real time;

Setting of Power Change for Downlink Closed Loop Power Control in real time;

Processing Uplink Open Loop Power Control in real time; and

Detecting Downlink Paging in real time.

In accordance with one embodiment of the present invention, the software portion of the CPC modem (running on a processor associated with the electronic computing device) is configured to provide the functions of the L2 and L3 layers and some or all of the functions of the L1 layer while the CPC modem hardware provides at least the RF processing needed to transceive a baseband signal comprised of sampled “chips” of the baseband telecommunications signal to and from the CPU of the electronic computing device for further processing.

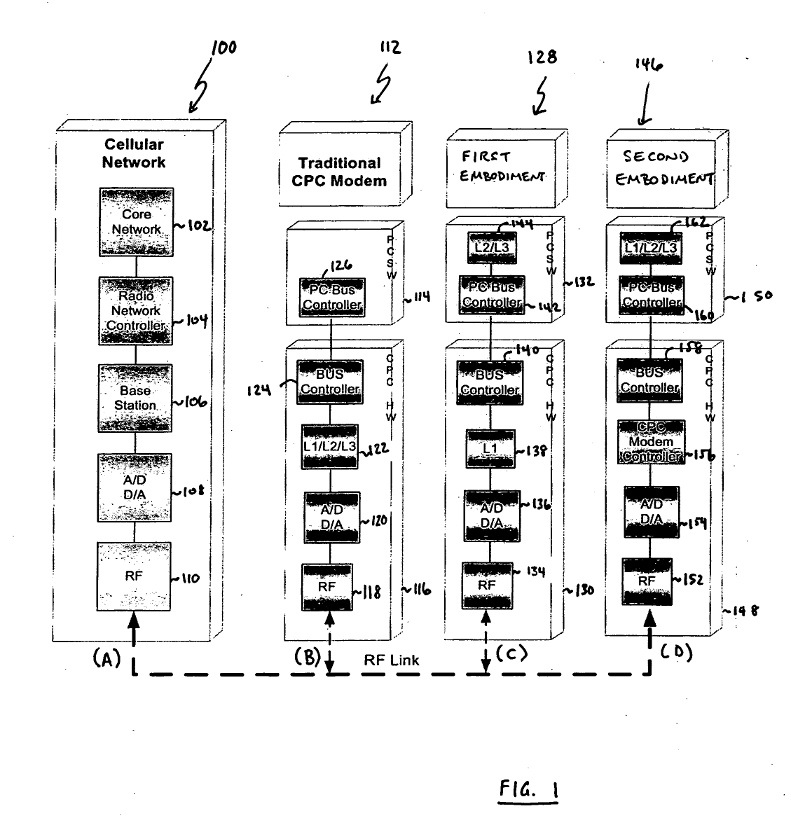

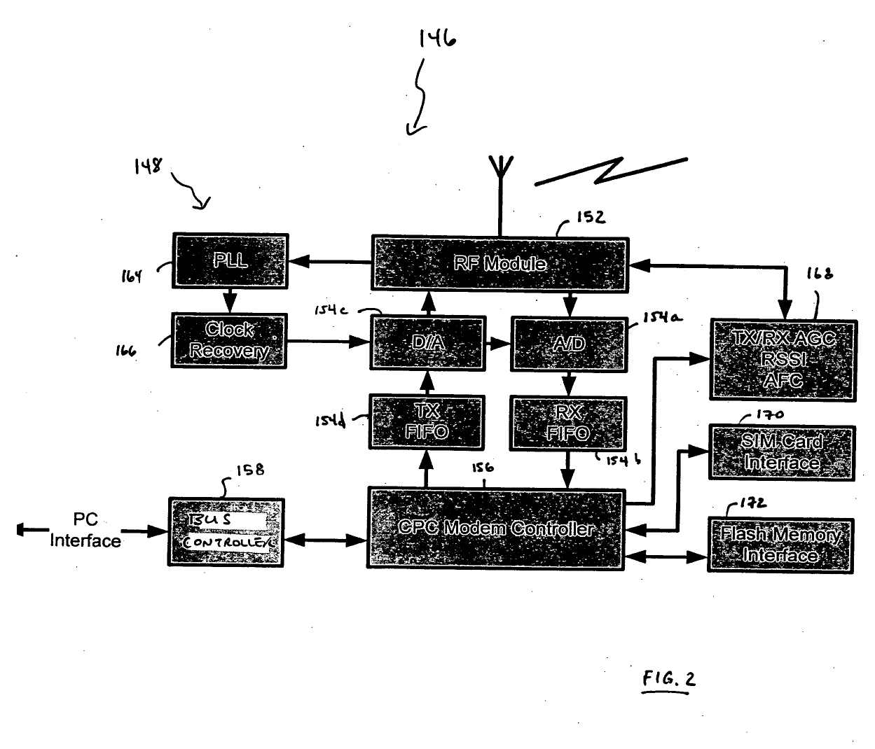

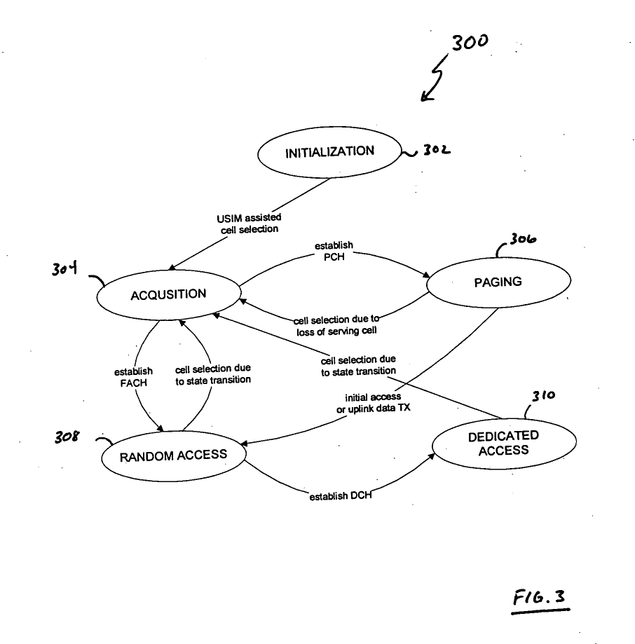

Turning now to the figures, FIG. 1A is a system block diagram illustrating a conventional cellular data communications network 100 in accordance with the prior art. The cellular network 100 comprises a core network 102, a radio network controller 104, one or more base stations 106, A/D (analog to digital) and D/A (digital to analog) processing functions 108, and RF (radio frequency) transceive functions 110 which are used to communicate wirelessly with, among other things, CPC modems associated with electronic computing devices.

FIG. 1B is a system block diagram illustrating a traditional CPC modem 112 in accordance with the prior art. In accordance with this prior art embodiment of a CPC modem, there are two portions—a software portion 114 and a hardware portion 116. The hardware portion 116 comprises (1) an RF transceive function 118 for communicating wirelessly with RF transceive function 110 of the cellular network 100; (2) A/D and D/A processing functions 120 which, on the A/D side provide digital signals which can be further processed by the CPC modem 112 and on the D/A side provide an analog signal to the RF transceive function 118 for transmission; (3) layer L1, L2 and L3 functionality 122; and (4) a bus controller 124 for controlling the data bus which communicates between the CPC modem 112 and the electronic computing device. The software portion 114 comprises a bus controller 126 for communicating with bus controller 122 and operating under control of the electronic computing device.

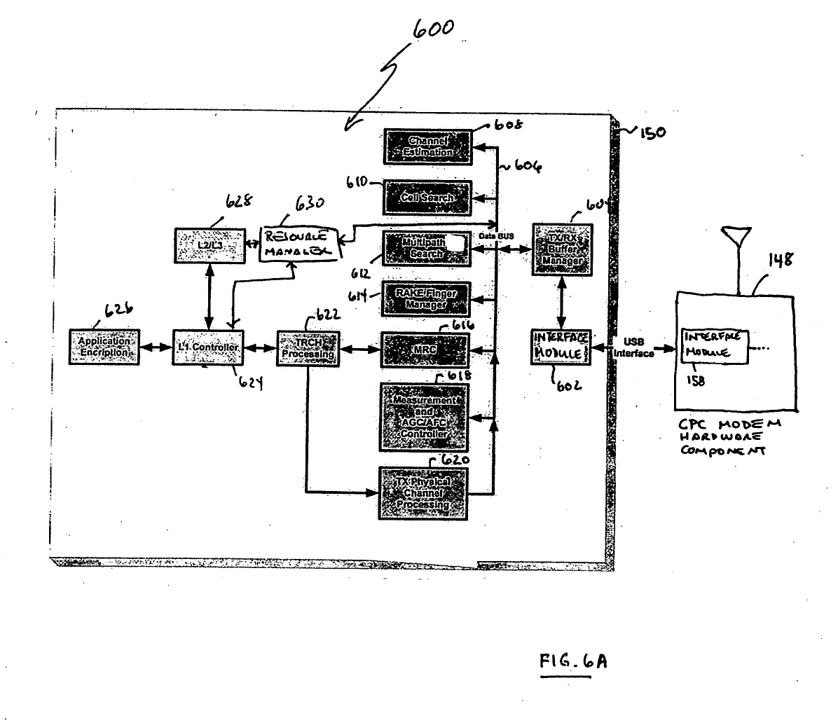

FIG. 1C is a system block diagram illustrating a first embodiment 128 of a CPC modem in accordance with the present invention. In accordance with this embodiment of the present invention, the CPC modem 128 is implemented in two parts, a hardware part 130 and a software part 132. The hardware part 130 comprises: (1) an RF transceive function 134 (also sometimes referred to herein as an “RF Module”) for communicating wirelessly with RF transceive function 110 of the cellular network 100; (2) A/D and D/A processing functions 136 (also sometimes referred to herein as, respectively, “A/D Converter” and “D/A Converter”) which, on the A/D side provide digital signals which can be further processed by the CPC modem 128 in accordance with the present invention and on the D/A side provide an analog signal to the RF transceive function 134 for transmission; (3) an L1 block 138 which carries out some or all of the L1 protocol processing in hardware (see discussion regarding FIGS. 5A and 5B, below); and (4) a bus controller 140 (also sometimes referred to herein as an “Interface Module”) for controlling the data bus which communicates between the CPC modem 128 and the electronic computing device on which is resident the processor running the software portion 132. The software portion 132 comprises: (1) a bus controller 142 (which may be partly or wholly implemented in hardware) for communicating with bus controller 140 and operating under control of the electronic computing device; and (2) a block 144 which carries out all of the L2 and L3 protocol processing in software as discussed in more detail below.

FIG. 1D is a system block diagram illustrating a second embodiment 146 of a CPC modem in accordance with the present invention. In accordance with this embodiment of the present invention, the CPC modem 146 is implemented in two portions, a hardware portion 148 and a software portion 150. The hardware portion 148 comprises: (1) an RF transceive function 152 (also referred to sometimes herein as an “RF Module”) for communicating wirelessly with RF transceive function 110 of the cellular network 100; (2) A/D and D/A processing functions 154 (also sometimes referred to herein as, respectively, “A/D Converter” and “D/A Converter”) which, on the A/D side provide digital signals which can be further processed by the CPC modem 146 in accordance with the present invention and on the D/A side provide an analog signal to the RF transceive function 152 for transmission; (3) a CPC modem controller block 156 which carries out control operations for controlling the CPC modem hardware portion 148; and (4) a bus controller 158 (also sometimes referred to herein as an “Interface Module”) for controlling the data bus which communicates between the CPC modem 146 and the electronic computing device on which is resident the processor running the software portion 150. The software portion 150 comprises: (1) a bus controller 160 (which may be partly or wholly implemented in hardware) for communicating with bus controller 158 and operating under control of the electronic computing device; and (2) a block 162 which carries out all of the L1, L2 and L3 protocol processing in software as discussed in more detail below.

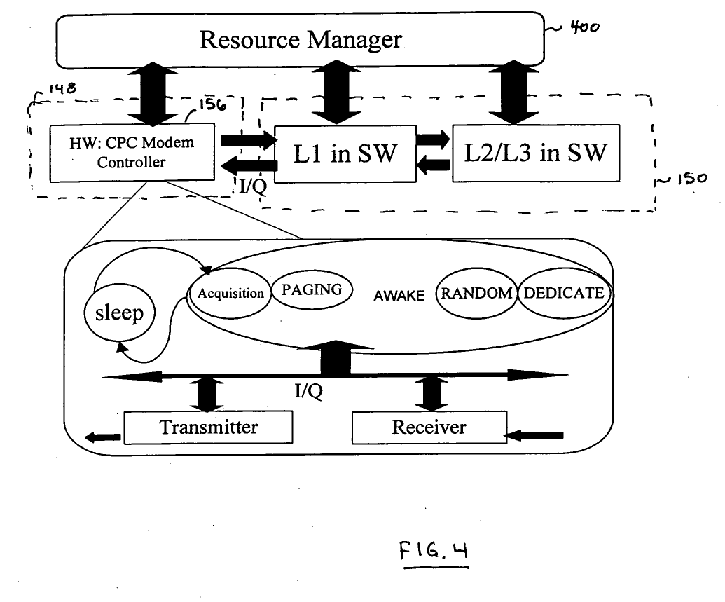

FIG. 2 is a system block diagram of the hardware portion 148 of a CPC modem 146 in accordance with the second embodiment of the present invention. Note that while embodiments of the present invention are discussed in an implementation utilizing the 3gpp, CDMA and GSM/UMTS standards, the invention is easily adapted to any future wireless data telecommunication system and the invention is not to be limited to any particular cellular data communications implementation.

In FIG. 2. the hardware portion 148 of CPC modem 146 is shown in more detail than in FIG. 1D. A/D-D/A module 154 here includes a separate A/D processing block 154a coupled to receive its input from RF module 152 and provide its output to a receive (RX) first in first out (FIFO) buffer (RX FIFO) (also sometimes referred to herein as a “Receive Buffer”) which is, in turn, coupled to provide an input to CPC modem controller 156 (sometimes simply referred to as “Controller”). Similarly, A/D-D/A module 154 also includes a separate D/A processing block 154c coupled to provide its output to RF module 152 and to receive its input from transmit (TX) FIFO (TX FIFO) buffer 154d (also sometimes referred to herein as a “Transmit Buffer”). TX FIFO buffer 154d receives digital information from CPC modem controller 156. Phase Locked Loop module (PLL) 164 and clock recovery module 166 are provided to control the operation of RF module 152 and provide a clock signal, respectively, as well known in the art. Block 168 provides transmit and receive automatic gain control for RF module 152 under control of CPC modem controller 156. SIM Card interface 170 provides an interface between CPC modem controller 156 and a SIM Card, generally used for data storage and network access, accounting and authorization. A flash memory interface 172 is provided for data storage by CPC model controller 156. A bus controller 158 (also sometimes referred to herein as “Interface Module”) is also provided as described above.

The components and architecture used for the CPC modem design (illustrated in FIG. 2) are described in more detail in the following paragraphs. While the following description is based on the W-CDMA (Wideband Code-Division Multiple-Access) standard, these general principles are applicable to other CDMA-based CPC modem designs, and the like:
L1 Mechanism: provide baseband signal processing functions as defined in the 3gpp standard;
L2 Mechanism: Media Access Control (MAC) and Radio Link Control (RLC) defined as in the 3gpp standard; and
L3 Mechanism: Radio Resource Control (RRC) and Core Network functions as defined in the 3gpp standard.
   Hardware

The CPC modem must react to a real-world environment, which is inherently concurrent. FIG. 2 provides an illustration of the hardware architecture. The hardware-implemented functions are specified in the following models of transmitter, receiver, and CPC modem controller. These are described below in terms of state machines which those of ordinary skill in the art will be readily able to implement in appropriate software/firmware for their specific applications with additional reference to the appropriate telecommunications standards.

Transmitter

The transmitter state machine includes three states: OFF, IDLE, and FRAME_TX. The meaning of states OFF, IDLE, and FRAME_TX is as follows:

OFF state: On reset, the state machine enters the initial OFF state. In this state, transmission from L1 to a bus link is disabled. Thus, nothing is transmitted to the bus. L2/L3 controls the transition from OFF state to IDLE state.

IDLE state: the transmitter continuously transmits DPCCH (Dedicated Physical Control CHannel) information based on which the receiver end can obtain samples (“chips”). The transmitter state machine always remains in state IDLE to allow L1 to prepare the configuration to send to the transmitter.

FRAME_TX state: the transmission of the valid frame structure is performed. Valid messages from the Application/Transport layer are transmitted as well as empty messages.

Receiver

The Receiver state machine includes three states: UNSYNC, BUS_SYNC, and FRAME_SYNC. The meaning of states UNSYNC, BUS_SYNC, and FRAME_SYNC is as follows:

UNSYNC: Bus link is down. A lot of byte errors are detected.

BUS_SYNC: Bus link is working, i.e., a connection exists.

FRAME_SYNC: Normal operational mode. Frame structure is detected and messages are received.

On reset, the receiver state machine enters the state UNSYNC. State transition to BUS_SYNC is done if consecutive blocks of bytes (“chips”) have been properly received. Transition from state BUS_SYNC back to UNSYNC is done if consecutive invalid byte blocks are received or in case of HW reset. Frame boundary is indicated by L1 to make transition from BUS_SYNC to FRAME_SYNC or from FRAME_SYNC to BUS_SYNC.

CPC Modem Controller

The CPC modem controller includes five states illustrated in the process flow 300 of FIG. 3: INITIALIZATION STATE 302, ACQUISITION STATE 304, PAGING STATE 306, RANDOM ACCESS STATE 308 and DEDICATED ACCESS STATE 310. The operation and interplay of these five states is illustrated in FIG. 3 which is a process flow diagram/state diagram illustrating the operation of a CPC modem controller, such as that illustrated in FIG. 2, in accordance with one embodiment of the present invention. These five states are described below.

INITIALIZATION STATE: In this state the L1 is initialized. This state can be entered either as a result of power Lip or from any other state via RESET as a result of any error condition or malfunction. The ACQUISITION STATE is only one possible next state.

ACQUISITION STATE: In this state two main functions are performed—serving cell selection and/or RF channel selection. Network selection is also orchestrated in this state by higher layers. L1 cannot determine the network identity directly. CPC modem controller 156 can be in this state either as a result of a successful initialization, ‘losing’ the serving cell, or other cell selection triggers as instructed by a higher layer. There are three possible next states: ACQUISITION STATE (nothing found, example: no in-band power on any RF channel), PAGING STATE (a cell found and PCH (Paging CHannel) is established), or RANDOM ACCESS STATE (a cell found and FACH (Forward Access CHannel) is established). In this state the following physical channels are applicable: SCH (Synchronization CHannel), CPICH (Common PIlot CHannel) and P-CCPCH (Priority Common Control Physical CHannel). The only applicable transport channel in this state is the BCH (Broadcast CHannel). In this state, L1 controls incoming I/Q data receiving and determines when frame synchronization is achieved. L1 also informs the CPC modem controller 156 of the slot and frame boundaries of incoming I/Q data.

PAGING STATE: The CPC modem controller 156 will be in this state most of the time if the UE (User Equipment) is not in RANDOM ACCESS STATE or DEDICATED ACCESS STATE. The main functions to be performed in this state are RF channel reselection, cell reselection, paging channel monitoring and discontinuous reception control. There are two possible next states, ACQUISITION STATE or RANDOM ACCESS STATE. In this state the following physical channels are applicable: SCH, CPICH, P-CCPCH, S-CCPCH (Secondary Common Control Physical CHannel) and PICH (Page Indicator CHannel). The following transport channels are also applicable: BCH and PCH:

The PAGING STATE includes several sub-states:

CONFIGURE STATE: L1 calculates a Paging Occasion for a specific user, and paging configurations are sent into a configuration buffer of the CPC modem controller 156.

PROCESSING STATE: during a Paging Occasion, incoming chip data is examined to determine whether the CPC modem is paged, and PCH decoding is sent to L1.

RANDOM ACCESS STATE: In this state the UE accesses the air interface using DOWNLINK and/or UPLINK random access channels. RF channel reselection and cell reselection also take place in this state. The CPC modem controller 156 can enter this state from PAGING STATE or DEDICATED ACCESS STATE. The next state can be either the ACQUISITION STATE or the RANDOM ACCESS STATE. In this state the following physical channels are applicable: SCH, CPICH, P-CCPCH, S-CCPCH, PRACH (Physical Random Access CHannel) and AICH (Acquisition Indicator CHannel). The following transport channels are also applicable: BCH, FACH and RACH (Random Access CHannel). The RANDOM ACCESS STATE includes several sub-states:

CONFIGURE STATE: L1 calculates chip data patterns of AICH ACK/NAK bits based on base station scrambling code and channelization code. The chip data patterns are sent into a configuration buffer of the CPC modem controller 156.

PROCESSING STATE: chip data patterns of AICH ACK/NAK bits are compared with incoming chip data to determine the value of AICH ACK/NAK bits. If ACK is detected then transmit RACH message. If NAK is detected then inform L1. If none is detected then increase transmitting power per upper layer configurations.

DEDICATED ACCESS STATE: In this state the UE accesses the air interface using DOWNLINK and UPLINK dedicated channels. Common actions taken in this state are RL (Radio Link) modification and physical and transport channel reconfigurations. The CPC modem controller 156 can enter this state from the RANDOM ACCESS STATE. The next state is the ACQUISITION STATE.

The DEDICATED ACCESS STATE includes several sub-states:

CONFIGURE STATE: L1 calculates chip data patterns of UPLINK power control bits (0 or 1) based on base station scrambling code and channelization code. The chip data patterns are sent to a configuration buffer of the CPC modem controller 156.

PROCESSING STATE: the chip data patterns of UPLINK power control bits are compared with incoming chip data to determine the UPLINK power control bit. If the UPLINK power control bit=1 then the transmitter power will be increased, otherwise the transmitter power will be decreased.

Software: Resource Management

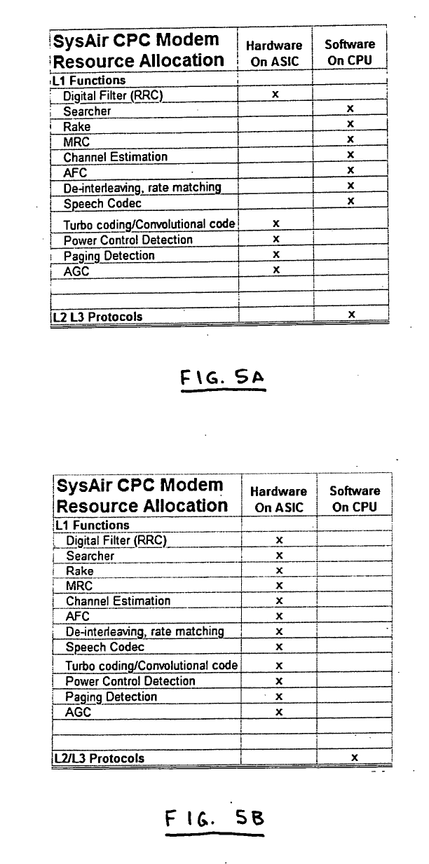

The software component provides a resource management platform for the CPC modem. Wireless applications typically have multiple flows of control and data. A CPC modem can sense the environment, forwards packets and receive commands all at the same time. The architecture needs to support concurrency in the application as well as to explore and utilize the concurrency in the heterogeneous architecture. Since the architecture has the global “view” of the system, it can also perform global resource management to optimize the system power consumption. Essentially, the mechanism is realized as a Resource Manager in the software component which provides resource management functions as shown in FIG. 4.

FIG. 4 is a system block diagram illustrating integration scenarios of layers L1, L2, L3, and a CPC modem controller in accordance with one embodiment of the present invention. In FIG. 4 the flow of information in accordance with an embodiment in which L2, L3 and at least a portion of L1 are implemented in software 150 running on a CPU of an electronic computing device is shown. CPC modem controller 156 is implemented in the hardware portion 148 discussed above and is in communication with the L1 block implemented in software as discussed above and the L1 block is in communication with the L2 and L3 blocks as shown. All of L1, L2, L3 and the CPC Modem Controller are in communication with a Resource Manager 400 implemented in software and running on the CPU. The Resource Manager operates to monitor conditions in the electronic computing device and the CPC modem and control operation of the CPC modem to prevent resource conflicts with the electronic computing device, e.g., to allocate enough resources for L1, L2, L3, and the CPC modem controller to process chips in time.

The flexibility of the invented architecture permits various resource allocation scenarios. Examples of this are illustrated in FIGS. 5A and 5B. FIG. 5A is a table showing a resource allocation scenario wherein the functions of layers L2 and L3 and a portion of the functions of layer L1 are carried out in software on a CPU associated with the electronic computing device in accordance with one embodiment of the present invention. FIG. 5B is a table showing a resource allocation scenario wherein the functions of layers L2 and L3 are carried out in software on a processor associated with the electronic computing device and the functions of layer L1 are carried out in hardware of the CPC modem in accordance with one embodiment of the present invention.

In the embodiment illustrated in FIG. 5A, in addition to the L2 and L3 protocol functions, the following L1 functions (all well known standard cellular data communication functions) are carried out in software running on the processor of the electronic computing device: searcher, rake, MRC, channel estimation, AFC, de-interleaving, rate matching and speech CODEC. The hardware of the CPC modem carries out the remaining functions.

In the embodiment illustrated in FIG. 5B, the software handles all L2 and L3 functions while the CPC modem hardware handles all L1 functions. Those of ordinary skill in the art will now recognize that other configurations are possible and within the scope of the inventive concepts disclosed herein.

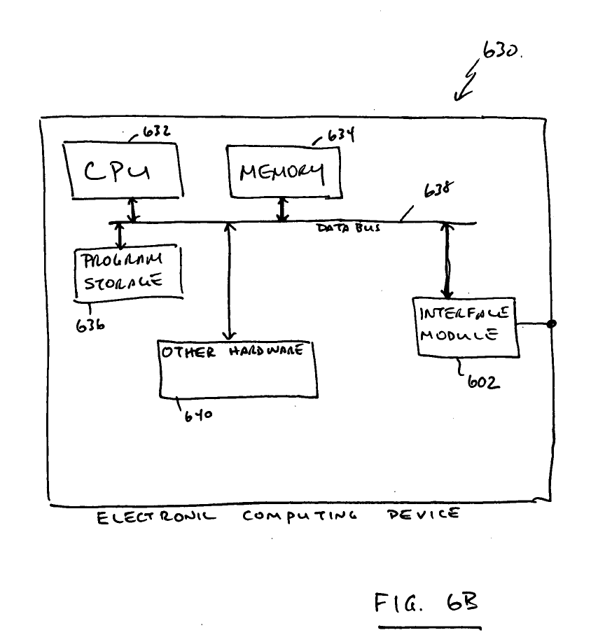

FIG. 6A is a system block diagram illustrating the functional blocks of the software component of the CPC modem executed by the processor of an electronic computing device to which the CPC modem is coupled in accordance with one embodiment of the present invention. FIG. 6B is a system block diagram illustrating the arrangement of major components of an electronic computing device for running the software of FIG. 6A.

The software component 600 of the CPC modem 146 (for example) is coupled to the CPC modem hardware component 148 via an interface module 602 such as a USB 2.0 interface and driver in a conventional manner. A transceiver buffer manager 604 manages communications through the interface module 602 in a conventional manner. A data bus 606 implemented in software communicates data among the major software components as shown. These components include software versions of standard cellular data telecommunications functions such as: channel estimation 608, cell search 610, multi-path search 612, rake finger manager 614, MRC 616, measurement and AGC/AFC controller 618 and TX physical channel processing 620. The TRCH processing block 622 is coupled to the MRC block 616 and TX physical channel processing block 620. The L1 controller processing block 624 is coupled to the TRCH processing block 622, to application encryption block 626, to L2/L3 protocol processing block 628 and to Resource Manager block 630 (which is also coupled to the L1 block 624 and the data bus 606).

Turning to FIG. 6B, an electronic computing device 630 includes a processor or CPU 632 with associated memory 634, program storage 636, interface module 602, data bus 638 and other hardware 640 which can include I/O devices such as keyboards, displays, mouse input devices and the like as well as all other conventional parts of electronic computing devices which are well known to those of ordinary skill in the art.

Major CPC modem software procedures to integrate L1, L2, and L3 are shown as follows:

Cell Selection

The cell selection procedure runs with the purpose of finding a cell which is suitable or acceptable (3gpp TS 25.304).

In the successful case, a suitable or acceptable cell is actually found. Following this, cell reselection process becomes active and operates as follows:
(1) Enable the CPC modem controller to receive chip data for cell selection;
(2) L1 starts scanning for cells using the frequency list to determine whether some channel/code group should be given priority during the scan. When L1 finds a cell, it starts forwarding scheduling information to L2/L3;
(3) After reception of scheduling information, while the cell is not fully evaluated for suitability/acceptability, L2/L3 schedules the remaining reception of information from the BCH;
(4) The Resource Manager instructs the CPC modem controller to turn on/off chip data base on the requested schedules, L2/L3 continues evaluation of the cell;
(5) L2/L3 finds the cell to be suitable or acceptable and instructs the CPC modem controller and L1 to continue reading the system information; and
(6) If the cell is suitable, cell reselection will start.

In the unsuccessful case, no suitable or acceptable cell is actually found. Accordingly, the CPC modem controller enters the fail/camped on any cell state and operates as follows:
(1) Enable the CPC modem controller to receive chip data for cell selection;
(2) L1 starts scanning for cells using the frequency list to determine whether some channel/code group should be given priority during the scan. When L1 finds a cell, it starts forwarding scheduling information to L2/L3;
(3) After the reception of scheduling information, while the cell is not fully evaluated for suitability/acceptability, L2/L3 schedules the remaining reception of information from the BCH;
(4) The Resource Manager instructs the CPC modem controller to turn on/off chip data base on the requested schedules, L2/L3 continues evaluation of the cell;
(5) L2/L3 finds the cell to be neither suitable nor acceptable. Enables CPC modem controller and L1 to continue search for another cell;
(6) Repeats step (5) for all searchable cells; and
(7) No further cells are found before the end of the channel scan. L1 confirms its completion of the channel scan. L2/L3 decide to start reading from a cell previously found acceptable but not suitable, and camped on the acceptable cell.
   Cellular Network Scanning

This process is started when a scan of all available UTRAN (UMTS Terrestrial Radio Access Network) cells must be carried out. This can happen either when the user requests manual selection mode, or initiated as a part of a network selection procedure specified in TS 25.304, TS 23.122 from 3gpp. Note that the procedure is different from cell selection in that:

The PCH must be monitored;

The BCH of current serving cell must remain valid;

The Serving cell is excluded from the search;

The process can be suspended/resumed by L2/L3;

No priority list of cells is given; and

Measurement must continue while performing network scan.

In the case that the Serving cell is the only available cell, no additional information is generated as no other cells found except the Serving cell.

In the case that additional cells are present:
(1) L2/L3 is camped on a cell. A network scan is required in order to determine which networks are present in the area;
(2) The Resource Manager instructs the CPC modem controller and L1 to start scanning for cells;
(3) L1 found a cell and returns the information to L2/L3;
(4) L2/L3 decode the system information and network ID; and
(5) Repeat steps 2-4 until L1 confirms to L2/L3 that no further cells are found.

In the case that the procedure is interrupted by cell reselection:
(1) L2/L3 is camped on a cell. A network scan is required in order to determine which networks are present in the area;
(2) The Resource Manager instructs the CPC modem controller and L1 to start scanning for cells;
(3) Cell reselection is triggered;
(4) L2/L3 suspends the scan and performs cell reselection;
(5) L2/L3 finally camped on the new serving cell;
(6) L2/L3 resumes the scan;
(7) The Resource Manager instructs the CPC modem controller and L1 to start scanning for cells;
(8) L1 found a cell and returns the information to L2/L3;
(9) L2/L3 decodes network ID; and
(10) Repeat steps 7-9 until L1 confirms to L2/L3 that no further cells are found.

In the case that the CPC modem controller is camped on any cell, a network scan is required. This operates as follows:
(1) L2/L3 is camped on a cell. A network scan is required in order to determine whether a suitable cell of the selected network can be found;
(2) The Resource Manager instructs the CPC modem controller and L1 to start scanning for cells;
(3) L1 found a cell and returns the information to L2/L3;
(4) L2/L3 decode the MIB and network ID;
(5) If the cell does not belong to the selected network then go to step 2 otherwise continue;
(6) The Resource Manager instructs the CPC modem controller and L1 to start reading more BCH;
(7) After decoding of additional system information, if the cell is determined to be unsuitable then go to step 8, otherwise the cell is determined to be suitable and the search is stopped, and L2/3 entered camped on a normal cell state; and
(8) Unless L1 confirms to L2/L3 that no further cells are found, go to step 2.

Cell Re-selection needs to provide:

RF channel list maintenance: implementation of an algorithm to cycle thru the channel list to minimize system acquisition time; and

Initial cell search list maintenance: once an RF channel to search has been selected this function will configure cell search hardware to find all cells transmitting on that specific frequency. Once “all” channel and cell data is available, a control algorithm selects a Serving cell that not only meets all 3gpp system requirements but also minimizes UE IDLE handover activity (failure to so minimize is the most often cited reason for inadequate battery standby time).

When Cell Re-selection is in IDLE, and Paging, the CPC modem controller supports DRX cycles (IDLE cycles) of various lengths, 0.64, 1.28, 2.56 and 5.12 s. The CPC modem controller evaluates the Cell Re-selection criteria for the cells, which have new measurement results available, at least every DRX cycle. The CPC modem controller performs cell reselection immediately after it has found a higher ranked suitable cell, unless less than 1 second has elapsed from the moment the CPC modem controller started camping on the Serving cell.

In the case that Cell Re-selection in the FACH and a successful cell reselection is performed:
(1) L2/L3 is camped on a suitable cell and idle mode measurement configuration had been received. Enable CPC modem controller and L1 for Reselection measurements are for the serving cell with cell reselection configuration and the neighbor cell lists from system information;
(2) L1 delivered CPICH measurement to L2/L3;
(3) L2/L3 filter and evaluate the measurement. If the set of cells are changed, for instance, measurement should be extended from Serving cell to intra-frequency cells, a new cell reselection configuration will be sent to L1;
(4) If Reselection triggered. L1 measurements are stopped;
(5) L2/L3 decode the network ID;
(6) if the cell belongs to the selected network, then the Resource Manager instructs the CPC modem controller and L1 to read more system information;
(7) if the cell is barred then request the next cell for system information reading;
(8) if none of the cells are suitable then go to step 10;
(9) After decoding of additional system information, the cell is determined to be suitable and the search is stopped;
(10) The Resource Manager instructs the CPC modem controller and L1 to read more system information from the new Serving cell;
(11) L2/L3 camped on the cell;
(12) Go to step 1 to start cell reselection again; and
(13) The CPC modem controller entered camped on any cell state, and start cell selection.
   Physical Channel Configuration/Reconfiguration and Transport Channel Reconfiguration

A number of examples for configuration and reconfiguration of L1 are now described:

In the case of transition from IDLE to FACH with a different RF frequency:
(1) The CPC modem is in IDLE mode with BCH and PCH allocated. Enable modem controller and L1 for RANDOM ACCESS STATE;
(2) L1 initializes connection frame timing base on 3gpp TS 25.331;
(3) L2/L3 signaling of RRC connection request/RRC connection setup;
(4) L2/L3 directs L1 to another RF frequency where cell selection must be done;
(5) The CPC modem controller releases associated channels (S-CCPCH, AICH, PRACH (Physical Random Access CHannel));
(6) The CPC modem controller configured L1 and BUS Control for cell selection on a specific frequency;
(7) The CPC Modem Controller camps on the new cell after system information is decoded;
(8) The CPC modem controller configures S-CCPCH, AICH, and PRACH; and
(9) L1 initializes timing counter for system timing.

In the case of transition from IDLE to DCH (Dedicated CHannel) with same RF frequency:
(1) The CPC modem is in IDLE mode with BCH and PCH allocated. Enable CPC modem controller and L1 for RANDOM ACCESS STATE;
(2) L1 initializes CFN (Connect Frame Number) based on 3gpp TS 25.331;
(3) L2/L3 signaling of RRC connection request/RRC connection setup;
(4) L2/L3 directs L1 to DCH mode with same RF frequency;
(5) The CPC modem controller releases the BCH;
(6) The CPC modem controller stops cell reselection measurement;
(7) The CPC modem controller releases FACH/RACH, associated channels and establishes DCH-related channels;
(8) L1 initializes CFN based on 3gpp 25.331;
(9) L2/L3 starts T312 timer, after N312 sync;
(10) L2/L3 configures measurement for DCH; and
(11) L2/L3 acknowledges to the network that it is in DCH mode

In the case of transition from DCH to FACH,
(1) L2/L3 stops measurement for DCH;
(2) The CPC modem controller releases DCH;
(3) Cell Selection base on;
(4) If within same network, L2/L3 requests decoding of the system information on the same cell;
(5) If across different network, L2/L3 requests selection of a cell on a new frequency;
(6) System info measurement info is returned to L2/L3;
(7) The CPC modem controller camps on the selected cell, and starts measurement for cell reselection;
(8) The CPC modem controller configures FACH for the selected cell; and
(9) L2/L3 acknowledges network; the reconfiguration is done.

While embodiments and applications of this invention have been shown and described, it would be apparent to those skilled in the art having the benefit of this disclosure that many more modifications than mentioned above are possible without departing from the inventive concepts herein. For example, while the invention has been discussed in the context of a portable electronic computing device, there is no reason why it could not be used with stationary electronic computing device such as a desktop computer or the like. The invention, therefore, is not to be restricted except in the spirit of the appended claims.

What is claimed is:

1. A telecommunications device for use with an electronic computing device having a processor, the device comprising:
an RF module configured to communicate with a cellular telecommunications network at a chip rate on a cellular telecommunications frequency;
a D/A converter coupled to the RF module and configured to provide the RF module with outgoing baseband analog signals for up-conversion to the cellular telecommunications frequency and transmission to the cellular telecommunications network, the D/A converter configured to operate at a sampling rate;
an A/D converter coupled to the RF module and configured to sample an incoming downconverted baseband waveform at the sampling rate;
a transmit buffer coupled to the D/A converter;
a receive buffer coupled to the A/D converter;
a controller coupled to the transmit buffer and to the receive buffer; and
an interface module coupled to the controller and configured to (1) forward the sampled baseband waveform to the electronic computing device, and (2) receive a sampled outgoing waveform from the electronic computing device and send it to the controller.

2. The device of claim 1 wherein the sampling rate is limited to two times the chip rate.

3. The device of claim 1, wherein the controller is configured to receive instructions from the processor via the interface module.

4. An electronic computing device, comprising:
a processor;
a storage device configured to store program instructions to be executed by the processor; and
a telecommunications device, including:
an RF module for communicating with a cellular telecommunications network at a chip rate on a cellular telecommunications frequency;
a D/A converter coupled to the RF module and configured to provide the RF module with outgoing baseband analog signals for up-conversion to the cellular telecommunications frequency and transmission to the cellular telecommunications network;
an A/D converter coupled to the RF module and configured to sample an incoming downconverted baseband waveform at a sampling rate;
a transmit buffer coupled to the D/A converter;
a receive buffer coupled to the A/D converter;
a controller coupled to the transmit buffer and to the receive buffer; and
an interface module coupled to the controller and configured to (1) forward the sampled baseband waveform to the electronic computing device, and (2) receive a sampled outgoing waveform from the electronic computing device and send it to the controller.

5. The electronic computing device of claim 4, wherein the program instructions are configured to cause the processor to act on the sampled baseband waveform received from the interface module.

6. The electronic computing device of claim 4, wherein the program instructions are configured to cause the processor to communicate data between the electronic computing device to the cellular telecommunications network.

7. The device of claim 4 wherein the sampling rate is limited to two times the chip rate.

8. The device of claim 5 wherein the sampling rate is limited to two times the chip rate.

9. The device of claim 6 wherein the sampling rate is limited to two times the chip rate.

10. The device of claim 4, wherein the controller is configured to receive instructions from the processor via the interface module.

11. The device of claim 5, wherein the controller is configured to receive instructions from the processor via the interface module.

12. The device of claim 6, wherein the controller is configured to receive instructions from the processor via the interface module.

13. The device of claim 4, wherein:
the processor is configured to process data link layer and netvork layer functions and provide instructions to the controller in response thereto.

14. The device of claim 13, wherein:
the processor is configured to process at least some physical layer functions and provide instructions to the controller in response thereto.

15. The device of claim 13, wherein:
the processor is configured to monitor conditions in both the electronic computing device and the telecommunications device and provide instructions to the controller in response thereto.

16. The device of claim 13, wherein:
the processor is configured to monitor conditions in both the electronic computing device and the telecommunications device and to control the operation of the telecommunications device so as to not interrupt the operation of the electronic computing device.

17. A method for carrying out data communication between a telecommunications device for use with an electronic computing device having a processor and a cellular telecommunications network, the method comprising:
receiving at a controllers a first baseband digital data signal for communication to the cellular telecommunications network from the processor via an interface module;
converting the first baseband digital data signal to a first baseband analog data signal at a transmit sampling rate;
up-converting the first baseband analog data signal to a first radio frequency (RF) signal;
transmitting the first RF signal at a transmit chip rate to the cellular telecommunications network;
receiving a second RF signal at a receive chip rate from the cellular telecommunications network;
down-converting the second RF signal to a second baseband analog data signal;
converting the second baseband analog data signal to a second baseband digital data signal at a receive sampling rate;
communicating the second baseband digital data signal to the controller; and
sending the second baseband digital data signal from the controller to the processor via the interface module.

18. The method of claim 17, further comprising:
limiting the receive sampling rate to two times the receive chip rate.

19. A method for carrying out data communication between (1) an electronic computing device having a processor and a telecommunications device coupled to the processor with an interface module, and (2) a cellular telecommunications network, the method comprising:
receiving at a controller of the telecommunications device a first baseband digital data signal for communication to the cellular telecommunications network from the processor of the electronic computing device via the interface module;
converting the first baseband digital data signal to a first baseband analog data signal at a transmit sampling rate;
up-converting the first baseband analog data signal to a first radio frequency (RF) signal;
transmitting the first RF signal at a transmit chip rate to the cellular telecommunications network;
receiving a second RF signal at a receive chip rate from the cellular telecommunications network;
down-converting the second RF signal to a second baseband analog data signal;
converting the second baseband analog data signal to a second baseband digital data signal at a receive sampling rate;
communicating the second baseband digital data signal to the controller; and
sending the second baseband digital data signal from the controller to the processor via the interface module.

20. The method of claim 19, further comprising:
limiting the receive sampling rate to two times the receive chip rate.

21. An apparatus for carrying out data communication between a telecommunications device for use with an electronic computing device having a processor and a cellular telecommunications network, the apparatus comprising:
means for receiving a first baseband digital data signal for communication to the cellular telecommunications network from the processor;
means for converting the first baseband digital data signal to a first baseband analog data signal at a transmit sampling rate;
means for up-converting the first baseband analog data signal to a first radio frequency (RF) signal;
means for transmitting the first RF signal at a transmit chip rate to the cellular telecommunications network;
means for receiving a second RF signal at a receive chip rate from the cellular telecommunications network;
means for down-converting the second RF signal to a second baseband analog data signal;
means for converting the second baseband analog data signal to a second baseband digital data signal at a receive sampling rate; and
means for sending the second baseband digital data signal to the processor.

22. An apparatus for carrying out data communication between (1) an electronic computing device having a processor and a telecommunications device coupled to the processor with an interface module, and (2) a cellular telecommunications network, the apparatus comprising:
means for receiving at the telecommunications device a first baseband digital data signal for communication to the cellular telecommunications network from the processor of the electronic computing device via the interface module;
means for converting the first baseband digital data signal to a first baseband analog data signal at a transmit sampling rate;
means for up-converting the first baseband analog data signal to a first radio frequency (RF) signal;
means for transmitting the first RF signal at a transmit chip rate to the cellular telecommunications network;
means for receiving a second RF signal at a receive chip rate from the cellular telecommunications network;
means for down-converting the second RF signal to a second baseband analog data signal;
means for converting the second baseband analog data signal to a second baseband digital data signal at a receive sampling rate; and
means for sending the second baseband digital data signal to the processor via the interface module.
